(19) United States
(12) Patent Application Publication
(10) Pub. No.: US 2024/0069304 A1
(43) Pub. Date: Feb. 29, 2024

(54) VOICE COIL MOTOR HELD IMMOBILE WHEN NOT IN USE, LENS MODULE, AND ELECTRONIC DEVICE

(71) Applicant: TRIPLE WIN TECHNOLOGY(SHENZHEN) CO.LTD., Shenzhen (CN)

(72) Inventors: YU-SHUAI LI, Shenzhen (CN); SHIN-WEN CHEN, Tu-Cheng (TW); KUN LI, Shenzhen (CN); JIAN-CHAO SONG, Shenzhen (CN); WU-TONG WANG, Jincheng (CN); DING FENG, Jincheng (CN)

(21) Appl. No.: 17/957,259

(22) Filed: Sep. 30, 2022

(30) Foreign Application Priority Data
Aug. 31, 2022 (CN) 202211062697.6

(51) Int. Cl. G02B 7/08

(52) U.S. Cl. CPC G02B 7/08

(57) ABSTRACT

A voice coil motor held immobile by magnetic attraction when not in use for photography purposes includes a base, a magnet fixed thereto, a carrier, a magnetic member, and a coil. The magnetic member is fixed to the carrier and is attracted by a permanent magnetic field (first MF) of the magnet on the base. The coil is fixed to the carrier and the magnetic member. When the voice coil motor is powered on, the coil generates a second magnetic field (second MF) opposing the first MF. The second MF reduces or eliminates the attractive force of the first MF of the magnet, to separate the carrier and its fittings and allow them to work freely. A lens module and an electronic device are further provided.

### FIELD

The subject matter herein generally relates to optical imaging technology, and more particularly, to a voice coil motor, a lens module, and an electronic device.

### BACKGROUND

A voice coil motor may include a housing, a magnet, a coil, a lens, and a carrier. The magnet is fixed on the housing. The coil and the lens are fixed on the carrier. The carrier can move relative to the housing when a current is applied to the coil, so that focus of the lens can be realized. However, when the voice coil motor is not in use, the components are not firmly fixed on the carrier and may slide relative to the housing and the fixed components, collisions and damage may occur. Therefore, there is a room for improvement in the art.

### BRIEF DESCRIPTION OF THE DRAWINGS

Implementations of the present technology will now be described, by way of example only, with reference to the attached figures.

FIG. 1 is a diagrammatic view of an embodiment of an electronic device for image-capturing according to the present disclosure.

FIG. 2 is a diagrammatic view of an embodiment of a lens module of the electronic device according to the present disclosure.

FIG. 3 is a diagrammatic view of an embodiment of a voice coil motor of the lens module according to the present disclosure.

FIG. 4 is an exploded view of the voice coil motor of FIG. 3.

FIG. 5 is a cross-sectional view of the voice coil motor of FIG. 3 when powered-off.

FIG. 6 is a cross-sectional view of the voice coil motor of FIG. 5 when powered-on.

FIG. 7 is a cross-sectional view of the voice coil motor of FIG. 6 at the moment when a current applied to the voice coil motor is cut off.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

Embodiments of the present disclosure will be described in detail with reference to the drawings. If no conflict, the following embodiments and features in the embodiments can be combined with each other.

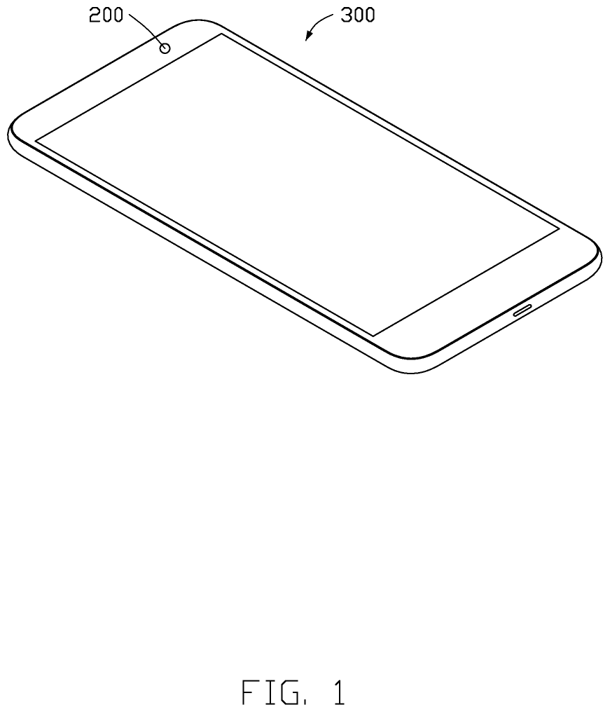

Referring to FIG. 1, an electronic device 300 is provided according to an embodiment of the present disclosure. The electronic device 300 includes a lens module 200. The electronic device 300 may be a mobile phone, a wearable device, a camera, a drone, or a doorbell. In the embodiment, the electronic device 300 is a mobile phone.

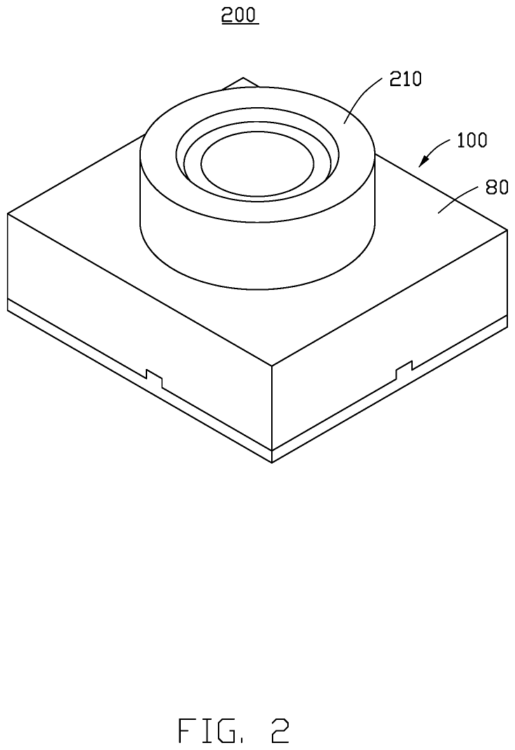

Referring to FIG. 2, an embodiment of the present disclosure further provides the lens module 200. The lens module 200 includes a voice coil motor 100 and a lens 210 accommodated in the voice coil motor 100.

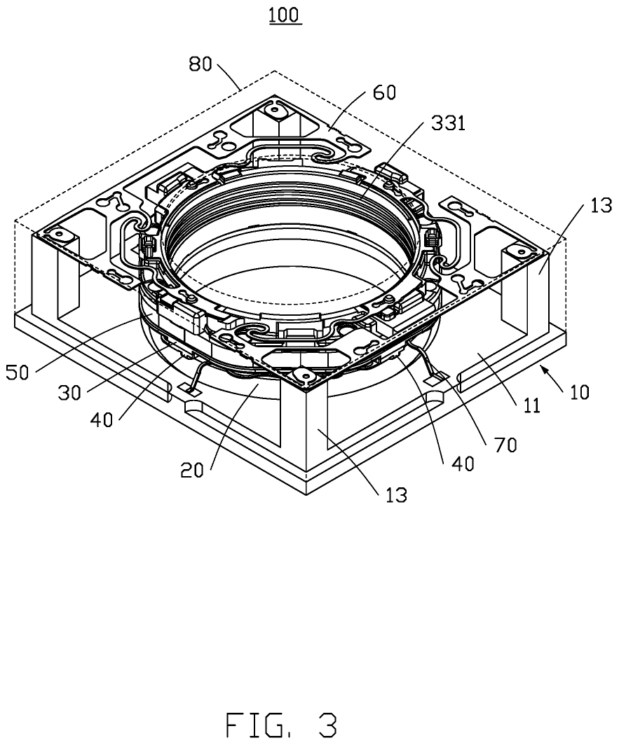

Referring to FIG. 3, an embodiment of the present disclosure provides the voice coil motor 100. The voice coil motor 100 includes a base 10, a magnet 20, a carrier 30, a magnetic member 40, and a coil 50. The magnet 20 is fixed to the base 10. The coil 50 and the magnetic member 40 are fixed to the carrier 30. The magnet 20 is always generating a first magnetic field and when the voice coil motor 100 is powered off (for example, image-capturing is not required), the first magnetic field attracts the magnetic member 40, so that the carrier 30 and the base 10 are effectively held and fixed to each other. When the voice coil motor 100 is powered on, a current applied to the coil 50 to cause it to generate a second magnetic field. A direction of the magnetic field of the second magnetic field is opposite to that of the first magnetic field. Thus, the second magnetic field reduces or cancels the attractive force of the first magnetic field of the magnet 20, so that the carrier 30 and the base 10 are separated and can work and move freely in relation to each other.

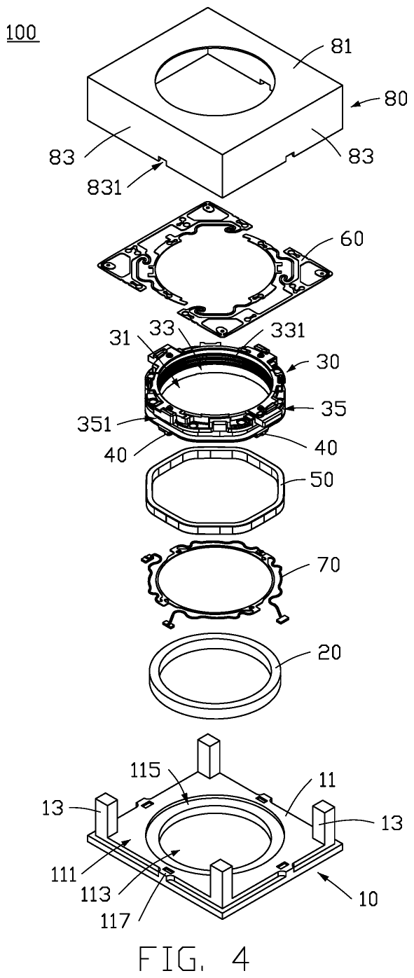

Referring to FIG. 4, the base 10 includes a bottom plate 11 and a plurality of supporting columns 13. The bottom plate 11 includes a supporting surface 111, and the supporting columns 13 are fixed on the supporting surface 111. In the embodiment, the bottom plate 11 is a square plate, the number of supporting columns 13 is four, and the four supporting columns 13 are disposed in four corners of the bottom plate 11. A first through hole 113 is defined on the bottom plate 11, the first through hole 113 penetrates opposite surfaces of the bottom plate 11, and the first through hole 113 provides space for the movement of the lens 210.

A groove 115 is also defined on the support surface 111. A portion of the support surface 111 surrounding the first through hole 113 is recessed toward a direction away from the supporting columns 13 to form the groove 115. The groove 115 communicates with the first through hole 113. In at least one embodiment, the groove 115 is annular.

The magnet 20 is fixed on the base 10. The magnet 20 is annular, and a portion at least of the magnet 20 is accommodated in the groove 115, the overall thickness of the voice coil motor 100 can thus be reduced.

The carrier 30 is substantially a hollow ring, and a second through hole 31 is defined on the carrier 30. The carrier 30 includes an inner surface 33 and an outer surface 35 opposite to the inner surface 33. The inner surface 33 is in fact an inner sidewall of the second through hole 31.

Threads 331 are defined on the inner surface 33, and the threads 331 engage with the lens 210 to fix the lens 210 on the carrier 30. An accommodating groove 351 is defined on the outer surface 35, and the accommodating groove 351 carries the coil 50.

The magnetic member 40 is fixed on the carrier 30. The magnetic member 40 includes magnetic elements, such as iron, cobalt, nickel, or alloys thereof. In the embodiment, the magnetic member 40 is an iron block. The magnetic member 40 is fixed on the carrier 30 and faces the magnet 20, thereby reducing a distance between the magnet 20 and the magnetic member 40. Thus, the force of the first magnetic field of the magnet 20 in relation to the magnetic member 40 is also reduced. That is, a strength of the first magnetic field is reduced, and the influence of the first magnetic field on the coil 50 is reduced. In other embodiments, the magnetic member 40 can also be fixed on other positions of the carrier 30.

At least a portion of the coil 50 is accommodated in the accommodating groove 351. When the voice coil motor 100 is powered on, the coil 50 moves according to the first magnetic field, and generates the second magnetic field. The direction of the second magnetic field is opposite to that of the first magnetic field, so that the force of the magnet 20 on the magnetic member 40 is reduced or eliminated. Thus, the carrier 30 and the base 10 are free of attraction towards each other and can move away from each other.

Furthermore, the magnetic member 40 is disposed in the second magnetic field, and the magnetic member 40 can enhance the strength of the second magnetic field generated by the coil 50. The magnetic member 40 can also be disposed around the carrier 30 and disposed inside the annular coil 50, which can further enhance the strength of the second magnetic field.

The voice coil motor 100 further includes an upper elastic piece 60 and a lower elastic piece 70. The upper elastic piece 60 and the lower elastic piece 70 are fixed on opposite sides of the carrier 30. The upper elastic piece 60 is disposed on a surface of the carrier 30 away from the bottom plate 11, fixed on the four supporting columns 13 by glue (not shown). The upper elastic piece 60 is also fixed on the surface of the carrier 30 facing away from the bottom plate 11. The lower elastic piece 70 is disposed on another surface of the carrier 30 facing the bottom plate 11 and fixed to the supporting surface 111. The lower elastic piece 70 is also fixed on the surface of the carrier 30 facing the bottom plate 11. Both the upper elastic piece 60 and the lower elastic piece 70 are elastic and deformable. The carrier 30 can thus move relative to the base 10, the upper elastic piece 60 and the lower elastic piece 70 are always urging the carrier 30 to return to its original position.

Before the upper elastic piece 60 and the lower elastic piece 70 are deformed, a certain gap exists between the magnetic member 40 and the magnet 20. When the magnetic member 40 attracted by the magnet 20 to fix the carrier 30 to the base 10, the upper elastic piece 60 and the lower elastic piece 70 are deformed to a certain extent. When the strength of the second magnetic field generated by the coil 50 in opposition to and greater than that of the first magnetic field from the magnet 20, the carrier 30 moves away from the bottom plate 11, and the upper elastic piece 60 and the lower elastic piece 70 are deformed.

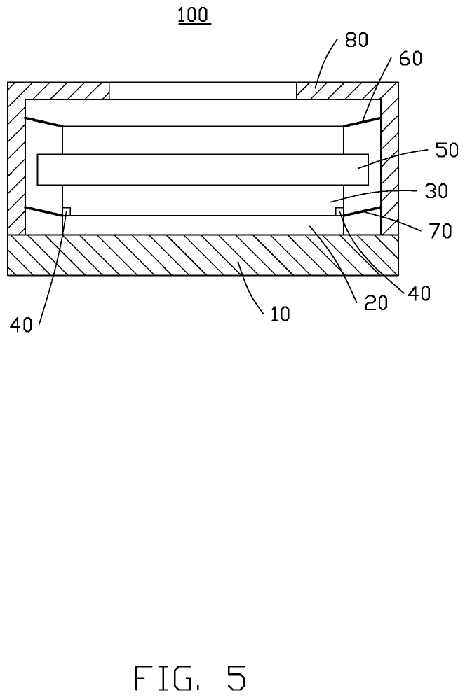

Referring to FIGS. 5 to 7, a working principle of the voice coil motor 100 is as follows.

Referring to FIG. 5, when the voice coil motor 100 is powered off, the magnet 20 continues to generate the first magnetic field to attract the magnetic member 40. Since the magnet 20 is fixed to the base 10, the magnetic member 40 is itself effectively fixed to the carrier 30. Therefore, the positions of the base 10, the magnet 20, the carrier 30, and the magnetic member 40 are relatively fixed, both the upper elastic piece 60 and the lower elastic piece 70 being deformed downward at this time.

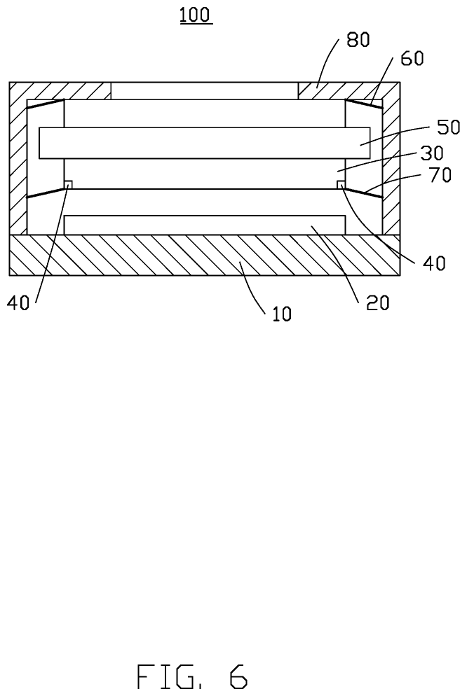

Referring to FIG. 6, when the voice coil motor 100 is powered on, the coil 50 moves in the first magnetic field and can generate the second magnetic field, the direction of the second magnetic field being opposite to that of the first magnetic field. The coil 50 repels the attraction by the magnet 20, reducing or canceling the attractive force of the magnet 20 on the magnetic member 40. When the strength of the second magnetic field is greater than that of the first magnetic field, the carrier 30 moves in a direction away from the bottom plate 11, so auto-focus for example can be realized by the voice coil motor 100. At the time, both the upper elastic piece 60 and the lower elastic piece 70 are deformed upward.

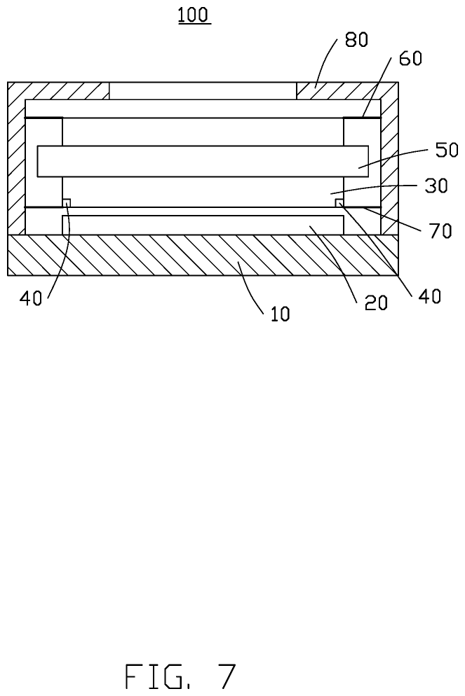

Referring to FIG. 7, when the current applied to the voice coil motor 100 is cut off, the second magnetic field disappears. The carrier 30 is in any event pulled toward the bottom plate 11 by the rebounding force of the upper elastic piece 60 and the lower elastic piece 70, and the magnetic member 40 is accordingly moved toward the bottom plate 11. Referring to FIG. 5 again, the magnet 20, now unopposed, further attracts the magnetic member 40 toward the bottom plate 11, thereby firmly fixing the carrier 30 to the base 10.

Referring to FIGS. 3 and 4, the lens module 200 further includes a housing 80. The housing 80 includes a top plate 81 and four side plates 83 surrounding the top plate 81. The housing 80 covers the base 10, and the side plates 83 facing away from the top plate 81 are connected to the bottom plate 11. The housing 80 and the base 10 form an accommodation space for accommodating the base 10, the magnet 20, the carrier 30, the magnetic member 40, and the coil 50.

The base 10 further includes a protruding portion 117. The protruding portion 117 is disposed on a surface of the bottom plate 11 connected to the housing 80. The housing 80 also includes a recessed portion 831. The recessed portion 831 is disposed on a surface of one of the side plates 83 connected to the base 10. The protruding portion 117 is accommodated in the recessed portion 831. The recessed portion 831 is matched with the protruding portion 117, facilitating assembly of the housing 80 and the base 10 together and preventing an offset or misalignment between the housing 80 and the base 10.

In some embodiments, the protruding portion 117 is disposed on the housing 80, and the recessed portion 831 is disposed on the base 10. In other embodiments, both the base 10 and the housing 80 are provided with both a protruding portion 117 and a recessed portion 831, as long as the above functions can be achieved.

When the voice coil motor 100 is powered off, the magnet 20 attracts the magnetic member 40, thereby fixing the carrier 30 on the base 10, reducing or eliminating the possibility of collision between adjacent components in the voice coil motor 100. When the voice coil motor 100 is powered on, the second magnetic field of the coil 50 repels the magnet 20, to separate the carrier 30 from the base 10 and allow free working. The magnet 20 is fixed on the base 10 of the carrier 30. The magnet 20 not only attracts the magnetic member 40, but also generates the first magnetic field, so that the coil 50 can move in the first magnetic field to generate the second magnetic field. In addition, the magnet 20 is disposed on one side of the coil 50, an area of the plane where the coil 50 is disposed is reduced, so that an overall volume of the voice coil motor 100 can be reduced. The magnetic member 40 is attracted by the magnet 20 to fix the carrier 30 on the base 10, and the field strength of the second magnetic field generated by the coil 50 is also enhanced.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A voice coil motor comprising:
a base;
a magnet fixed to the base, the magnet configured to generate a first magnetic field;
a carrier movably connected to the base;
a magnetic member attracted by the magnetic member, causing the carrier member to fixed to the base; and
a coil fixed to the carrier and the magnetic member,
wherein when the voice coil motor is powered on, the coil is configured to generate a second magnetic field, and a direction of the second magnetic field is opposite to a direction of the first magnetic field.

2. The voice coil motor of claim 1, wherein the magnetic member is disposed on a surface of the carrier facing the magnet.

3. The voice coil motor of claim 1, further comprising an upper elastic piece and a lower elastic piece, wherein the upper elastic piece and the lower elastic piece are fixed on opposite surfaces of the carrier; the upper elastic piece and the lower elastic piece are further fixed on the base, and the carrier and the base are connected to each other through the upper elastic piece and the lower elastic piece.

4. The voice coil motor of claim 3, wherein the base comprises a bottom plate and a plurality of supporting columns, the plurality of supporting columns is fixed on the bottom plate, the lower elastic piece is fixed on the bottom plate, and the upper elastic piece is fixed on the plurality of supporting columns.

5. The voice coil motor of claim 4, wherein a groove is defined on the base, and at least a portion of the magnet is accommodated in the groove.

6. The voice coil motor of claim 1, wherein an outer surface of the carrier defines a receiving groove, and at least a portion of the coil is received in the receiving groove.

7. The voice coil motor of claim 6, wherein threads are defined on an inner surface opposite of the carrier, the inner surface is opposite to the outer surface.

8. The voice coil motor of claim 1, further comprising a case covering the base.

9. A lens module comprising:
a voice coil motor comprising:
a base;
a magnet fixed to the base, the magnet configured to generate a first magnetic field;
a carrier movably connected to the base;
a magnetic member attracted by the magnetic member, causing the carrier member to fixed to the base; and
a coil fixed to the carrier and the magnetic member;
wherein when the voice coil motor is powered on, the coil is configured to generate a second magnetic field, and a direction of the second magnetic field is opposite to a direction of the first magnetic field.

10. The lens module of claim 9, wherein the magnetic member is disposed on a surface of the carrier facing the magnet.

11. The lens module of claim 9, further comprising an upper elastic piece and a lower elastic piece, wherein the upper elastic piece and the lower elastic piece are fixed on opposite surfaces of the carrier; the upper elastic piece and the lower elastic piece are further fixed on the base, and the carrier and the base are connected to each other through the upper elastic piece and the lower elastic piece.

12. The lens module of claim 11, wherein the base comprises a bottom plate and a plurality of supporting columns, the plurality of supporting columns is fixed on the bottom plate, the lower elastic piece is fixed on the bottom plate, and the upper elastic piece is fixed on the plurality of supporting columns.

13. The lens module of claim 12, wherein a groove is defined on the base, and at least a portion of the magnet is accommodated in the groove.

14. The lens module of claim 9, wherein an outer surface of the carrier defines a receiving groove, and at least a portion of the coil is received in the receiving groove.

15. The lens module of claim 14, wherein threads are defined on an inner surface opposite of the carrier, the inner surface is opposite to the outer surface.

16. The lens module of claim 9, further comprising a case covering the base.

17. An electronic device comprising
a lens module comprising:
a voice coil motor comprising:
a base;
a magnet fixed to the base, the magnet configured to generate a first magnetic field;
a carrier movably connected to the base;
a magnetic member attracted by the magnetic member, causing the carrier member to fixed to the base; and
a coil fixed to the carrier and the magnetic member;
wherein when the voice coil motor is powered on, the coil is configured to generate a second magnetic field, and a direction of the second magnetic field is opposite to a direction of the first magnetic field.

18. The electronic device of claim 17, wherein the magnetic member is disposed on a surface of the carrier facing the magnet.

19. The electronic device of claim 17, further comprising an upper elastic piece and a lower elastic piece, wherein the upper elastic piece and the lower elastic piece are fixed on opposite surfaces of the carrier; the upper elastic piece and the lower elastic piece are further fixed on the base, and the carrier and the base are connected to each other through the upper elastic piece and the lower elastic piece.

20. The electronic device of claim 19, wherein the base comprises a bottom plate and a plurality of supporting columns, the plurality of supporting columns is fixed on the bottom plate, the lower elastic piece is fixed on the bottom plate, and the upper elastic piece is fixed on the plurality of supporting columns.
